(19) United States
(12) Patent Application Publication
(10) Pub. No.: US 2020/0023524 A1
(43) Pub. Date: Jan. 23, 2020

(54) TRASH AND RECYCLE BIN RELOCATION ROBOT

(71) Applicant: Hesham Mohamed, Apex, NC (US)

(72) Inventor: Hesham Mohamed, Apex, NC (US)

(21) Appl. No.: 16/514,890

(22) Filed: Jul. 17, 2019

Related U.S. Application Data
(60) Provisional application No. 62/701,807, filed on Jul. 22, 2018.

(51) Int. Cl. B25J 11/00; G05D 1/02; G01S 15/93; B25J 5/00

(52) U.S. Cl. CPC B25J 11/008; B25J 5/007; G01S 15/931; G05D 1/0246

(57) ABSTRACT

A robot for moving trash bins and recycle bins from a storage area typically garage or driveway, to a curbside for engagement by garbage/recycle collection truck and then later the robot returns the bins back to their storage area. This works best with the commonly used two-wheel bins. The robot detects the location of the bins using a camera and artificial intelligence and lifts the bins off the ground using an arm and hook to drag the bins on their wheels to the curbside one at a time. The robot may distinguish between types of bins, the owner bins and other's bins by a barcode sticker. The robot detects its directions from driveway to curbside by either a line drawn on the ground and detected by its camera or by using a training method that keeps track of images on its way and uses artificial intelligent.

### CROSS-REFERENCE TO RELATED APPLICATION

The present application claims priority to a U.S. provisional patent application entitled “Trash can mover robot” filed Jul. 22, 2018 and assigned Ser. No. 62/701,807, disclosure of which in incorporated herein at least by reference.

### BACKGROUND OF THE INVENTION

### 1. Field of Invention

The present invention is a robot, and method of implementing said robot, to automate moving receptacles such as trash cans and recycle bins from their storage area (usually the garage or driveway) to the curbside so that they would be picked up by garbage/recycle collection cars vehicles and then later return them back to their storage area.

### 2. Description of Prior Art

Commonly used wheeled trash and recycle bins are typically made of plastic with wheels on each side, and the front of the bins rests on the ground. A bar is on the front side enabling one to lift said containers and roll or drag them to their intended destinations.

Usually, trash and recycle bins are stored on the driveway near/inside of the garage to be pushed out before the collection time via the driveway to curbside by someone living in the residence. Routine collection of trash and recycle for is usually done once a week by collecting trucks, that pick the bins from the street beside the curb.

Putting the trash and recycle bins out on the curb is difficult for some people as it requires them to physically move heavy bins when full, and if you forget to put them out you will have to wait for a week until the trucks come back, typically causing bins to overflow. After the bins are emptied, they must be moved back in their storage place near or inside of the garage. People with physical disabilities, advanced age or young, small stature individuals have extreme difficulties achieving movement of the bins week after week. Additionally, the trash company requires specific orientation of the bin so the handle always faces the street. Often the trash company will refuse to empty bins that are not positioned and oriented properly at the street at the right time and day requiring specific orientation of the bin so the handle always faces the street.

There had been other previous inventions that tried to solve the problem by having a special trash can that can drive itself by adding motors to it, but most trash companies require customers to rent specific bins that are proprietary to the company in type, structure and size so they may be automatically picked up and emptied into trucks via automated arms that engage with handles on the bins. Therefore, what is needed is a robot to automatically and correctly position bins at the street at the right day, time and position so the trash company may successfully empty said bins.

### BRIEF SUMMARY OF THE INVENTION

The present invention provides a robotic apparatus and method to automate the relocation of trash and recycle bins by building a multipurpose robot that can automatically move bins at certain programmable specified times. A wireless enabled controller is provided that may be operated from a cell phone or dedicated controller. The software may communicate with a city web site to detect what dates the trash and recycle is collected in its area to put the bins out. This robot is multipurpose and can do more functionality by adding more programs and to do different things like pushing a snow blower, pushing a gas grass mower, etc. The present invention provides a interacting with commonly used outdoor waste bins that do not need to be modified in order to interact with the robot, in addition it can be used for both trash can and recycle-bin which means half the cost, beside the robot does not stay on the curb side as it puts the bin in the collection place and then return to its storage location that can have a door like the pet door preventing it from being vulnerable to theft.

Some parts used in the robot of the present invention include a linear actuator motor, linear actuator board, proportional-integral-derivative (PID) motor controller, raspberry PI (Embedded Advanced reduced instruction set computing (RISC) Machine (ARM) control board, a surveillance camera that can rotate 360 degrees and can tilt up and down and is controlled and transmits it's images through a CAT5 connection. It also has IR LEDs that give it the capability of catching images even in complete dark. Artificial intelligence software may include “OpenCV” and “Tensor-flow” that are available. Artificial intelligence software capable of detecting objects through training them with big number of pictures of objects that we want to recognize and then when the software see a new picture it can detect the object in the picture returning back with the level of accuracy.

The present invention is a type of robot that would move trash can and recycle-bin from its storage location to the curbside on a certain pre-programed night every week and at a set time the robot may go to the trash can storage location and when it is in the right position the robot moves up its hook that is connected to the linear actuator until it reaches the trash can horizontal pipe or cylindrical shaped bin handle and may continue until the trash can side sitting on the ground is lifted few inches of the ground, enabling the robot to push or pull the bin on the bins wheels, which there are at least two. The robot pulls or pushes the bin along the drive way to the curbside and then returns back to do the same with the refuse or recycle-bin.

After collection time the robot goes out again to return the trash can and recycle-bin from beside the curb up the drive way to their original storage location. The robot knows its way by either: Tracking a line drawn (or duct tape) on the ground. This is done by using its camera to track the path to the bins location and then to the curb side. Use an artificial intelligence to know its path using pre-captured pictures of its way that the robot's camera took previously during a training session. During the training session the robot is controlled remotely using a controlling device (currently using Bluetooth joystick, but can be a smart phone or other) to go on the path from drive way to curb side and then back where it takes pictures every half a second and save it in the controller to be used later.

One embodiment provides a robot enabled to automatically relocate a refuse or recycle bin, comprising a housing including a top, bottom and four sides. A means for storing and execution of artificial intelligence software enabled to operate the robot. At least two support wheels operated by at least one electric motor and at least one ball caster may be included, at least one transmitter enabled to transmit ultrasound and one receiver enabled to receive the ultrasound, the transmitter and receiver mounted on at least one side of the housing, a camera enabled to rotate at least 300-360°; an articulated arm including one or more actuators enabled to extend and retract the arm; and an engagement handle enabled to engage a bin handle located on the refuse or recycle bin.

In this embodiment, the robot learns a location of one or more of the refuse or recycle bins, via input from the camera, transmitters and receivers, to the software, and at a predetermined day and time, travels to the refuse or recycle bin location, operates the arm and engagement handle to engage the bin handle of the refuse or recycle bin and pushes, pulls or lifts the refuse or recycle bin on second wheels to a curbside location for collection, and after collection, returns the refuse or recycle bin to the location.
Another embodiment may include that the engagement handle includes a semi-circular portion with straight sides extending away from the arm thereby forming a recess enabled to accept the handle of the refuse or recycle bin. Additionally, the at least two support wheels may each have a diameter greater than a height of the housing.

The robot of another embodiment may learn the location by following a direction line on ground between a resting location of the robot and the location of the refuse or recycle bin.

### BRIEF DESCRIPTION OF THE DRAWINGS

FIG. 1 is a front angle view of the robot.

FIG. 2 is a back angle view of the robot.

FIG. 3 depicts the robot actuator arm picking up the trash bin by engaging its hook.

FIG. 4 is a side perspective view of the robot with extended actuator arm.

FIG. 5 is an illustration to the robot from side view with contracted actuator Arm.

FIG. 6 shows a block diagram of the computerized controller of the robot.

FIG. 7A, 7B, 7C, 7D, 7E, 7F, 7G, 7H, are an illustration of software operating the robot.

FIG. 8 cross-sectional top view of the robot showing one way of component placement.

### DETAILED DESCRIPTION OF THE INVENTION

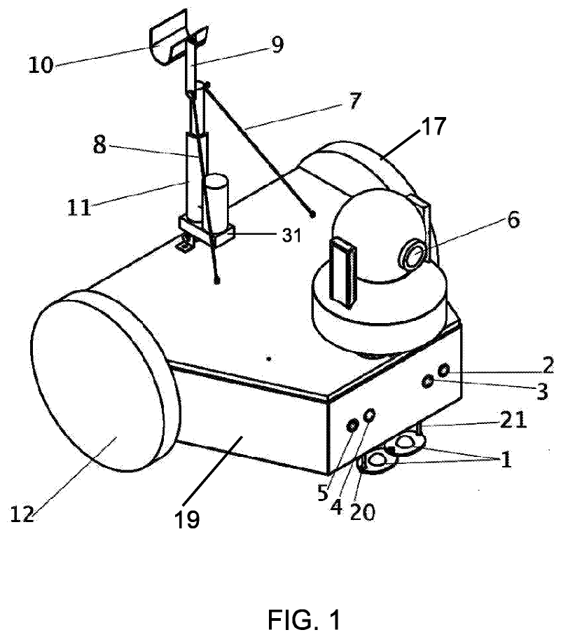

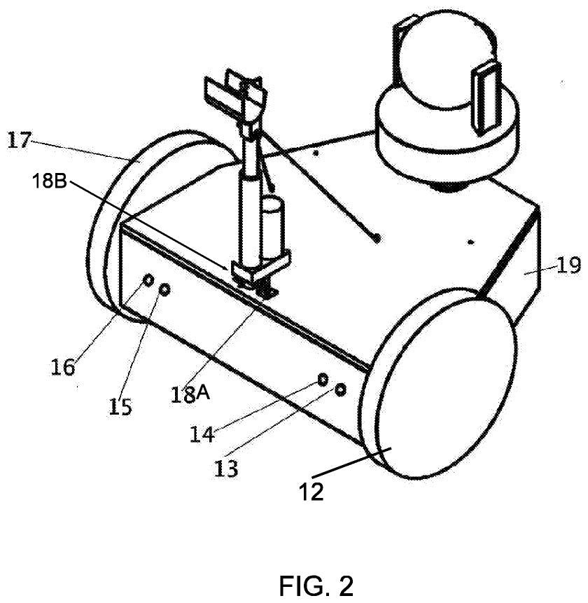

FIG. 1 shows a robot 19. The robot includes a wheel 12 that is rotated by an electric motor, a wheel 17 that is rotated by another electric motor.

In the front, there are two free-running ball casters 1 that are attached to the body of the robot by two long screws 20 and 21. The ball casters will give the robot the capability to rotate almost in the same place if the two wheels rotate at different directions.

The front has ultrasound transmitter 2 and receivers 3 that are used to avoid the collision and to detect the distance to objects by transmitting ultrasound from 2 and measuring the time taken to be received back by 3 then multiplying that by sound velocity giving us the distance. The same is ultrasound transmitter 4 and ultrasound receiver 5.

The robot has a camera 6 that sends its images to artificial intelligence software that recognize images and detects an object's place like trash can/recycle bin and distinguish it from those of the neighbors by a big barcode stuck on the bin.

Currently the artificial intelligence program used is OpenCV “Open computer vision” but can be “Tensor-flow” or other program that recognizes images by training them with many images of bins with different colors, and with different backgrounds to detect an object like the bin.

The robot can differentiate between bins (trash & recycle) by the color, size or barcode label. Preferably, the barcode would be located just under the handle. The camera is a market off-shelf product that can rotate 300-360 degrees and can tilt up and down up to 180 degrees from horizontal position. When the robot is driving backward the robot turns its camera 180 degrees so that it points to the back.

We can substitute the rotating Camera with two fixed cameras one at the front and one at the back.

The robot knows its path by the camera, either by tracking a line drawn on the ground (or a colored duct tape stuck to the ground) or using images captured taken during a training session and going to locations where it resembles those stored images.

The camera will be facing forward when pulling the bin to track the line on the ground or to compare images with pre-saved images. The camera will be facing backward toward the linear actuator when the robot is in processes of hooking to a bin.

A hook or handle 10 is attached to one end of an angle bar 9 that is attached from the other end to the arm of linear actuator 11. The hook is a U shaped made of metal to be light and rigid to lift the bin even when it is heavy and is capable of pulling it on the driveway. The angle bar is connected to the linear actuator's arm by a bolt and nut. While the angle bar is attached to hook by either bolt and nut or soldering.

The linear actuator is market off-shelf product that has a built-in mechanism to stop automatically on either extends. The linear actuator consists of a base 31 with two cylinders attached one is motor and the other is arm. The arm increases and decrease in length according to polarity of voltage applied to the motor. The lower side of the base has a metal extension that has a through hole.

Steel wires 7 and 8 are connected to the robot top case to the top of the linear actuator. They can also be made of just one piece of wire

FIG. 2 shows the robot from the back that includes the angle brackets 18A and 18B.

Ultrasound transmitters 13 and 15 and receiver 14 and 16 that are used to avoid collisions and to detect the distance to objects (especially the distance bin).

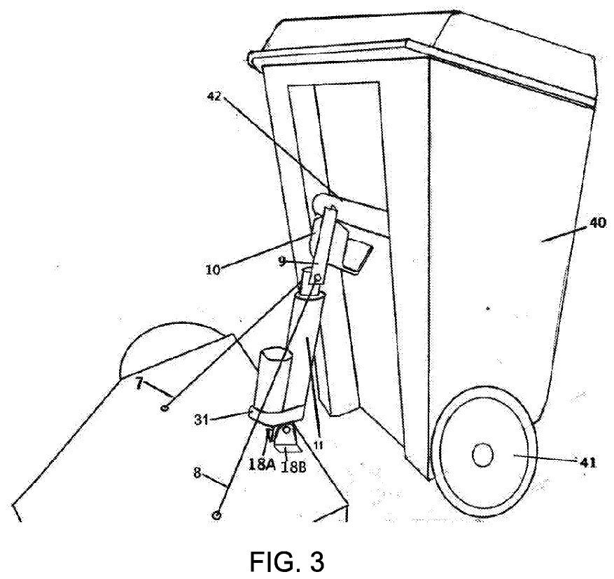

FIG. 3 shows the robot when trying to hook to bin 40 by increasing the arm length of the linear actuator arm until it reaches the horizontal pipe 42, and continue until the bin is lifted from one side to be over the ground enough to pull/push the bin over its wheels 41 with low friction.

The angle brackets has a bolt going through them and a hole at the lower part of linear actuator thus this combination acts as a hinge for the linear actuator.

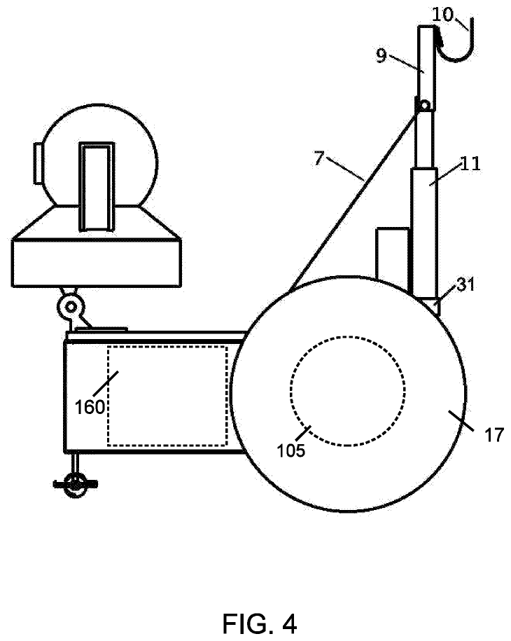

FIG. 4 shows the side-view of the robot with the location of a rechargeable batteries 160 that consist of one or more battery (currently we use two batteries)

Electric motor 105 is one that drives the wheel 17 to rotate.

When linear actuator expands it lifts the bin and at the same time, the linear actuator rotates over the lower hinge to be vertical, as the steel wires 7 and 8 will pull the linear actuator, thus puts the center of weight of the bin on the wheels of the robot and prevents the robot from flipping.

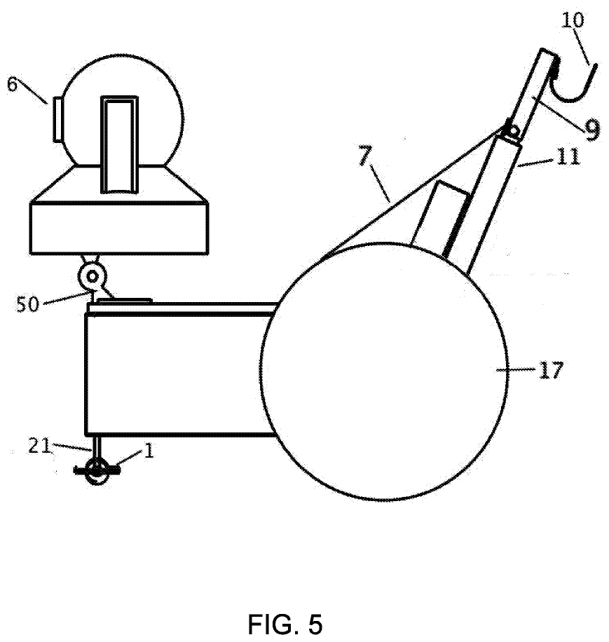

FIG. 5 shows the side-view of the robot with arm is contracted. This makes the linear actuator and the hook when short pointing out towards the bin at an acute angle about 60 degrees with horizontal, thus makes it easier for the hook to catch the horizontal pipe of the bin.

The Camera is attached to the robot with a mechanism underneath capable of putting it on a primary tilt angle even before using the electronically controlled tilt as the camera will need this extra tilt to be capable see the ground just in front of it to track the line on the ground.

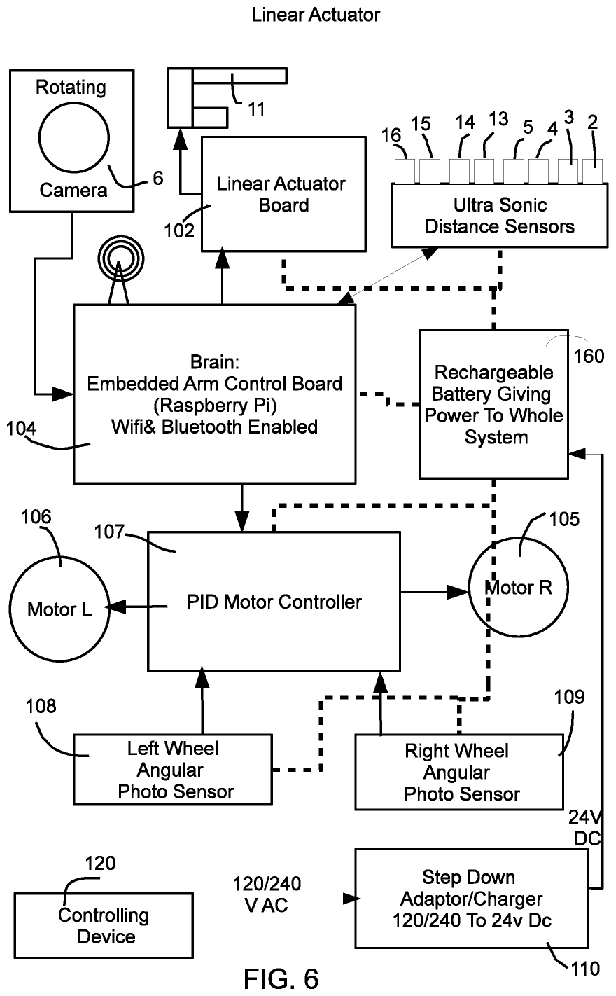

FIG. 6 is the robot's electrical block diagram that consists of the brain 104 an embedded microcomputer board currently using ‘Raspberry Pi 3’ that has a quad-core Arm processor (but may change it in future as technology evolves) running Linux OS, and currently uses OpenCV software for computer vision artificial intelligence (AI). Will reference it through the document as the Brain.

The PID (proportional integral deferential) motor control board 107 is market off-shelf product that communicates with the Brain using RS232 0-5V. The PID (proportional integral deferential) controls the two electric motors that drives wheels. Alternatively, a processor having software installed controls the robot.

Linear actuator board 102 is also market off-shelf board containing two relays that are controlled by the Brain GPIO pins, toggling relays positions reverse the polarity of the voltage applied to linear actuator motor thus causing the linear actuator arm to increase or decrease.

Step Down Adaptor/Charger 110 is market off-shelf product, it connects to the power outlet (120V 60 Hz/240 50 Hz) and produce 24V DC to charge the batteries through a wire that plugs to the robot until the batteries are charged then can be disconnected.

Controlling Device 120 is a wireless device to train the robot by controlling the robot movement and going all the way from the robot parking area to the bin and then to the curb, and back. While doing that the robot is taking pictures with its camera and those pictures will be used later by Artificial intelligence software (openCV) to find its way by trying to position the robot to the same locations of the pictures. The training is another option if putting a line on the ground is not desired or practical.

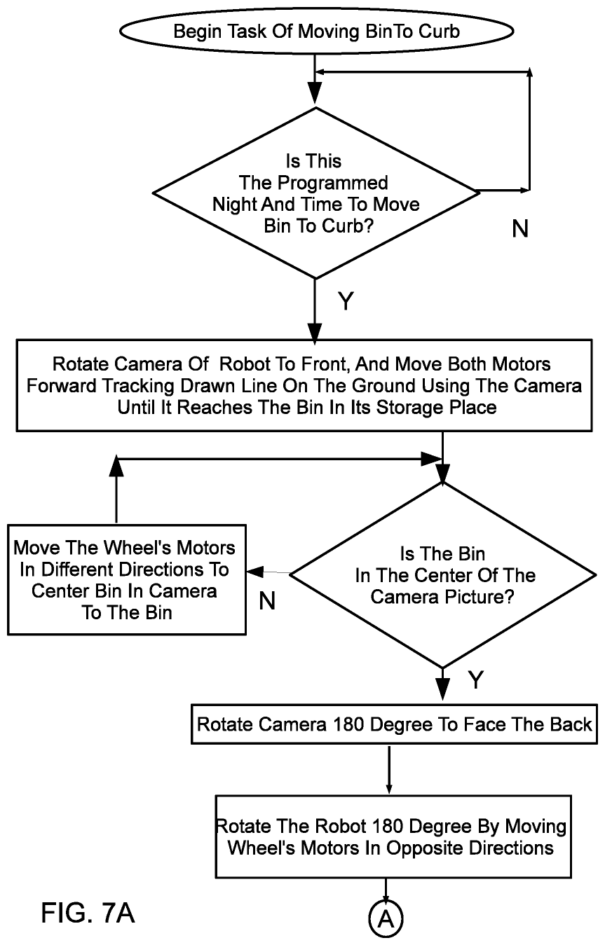

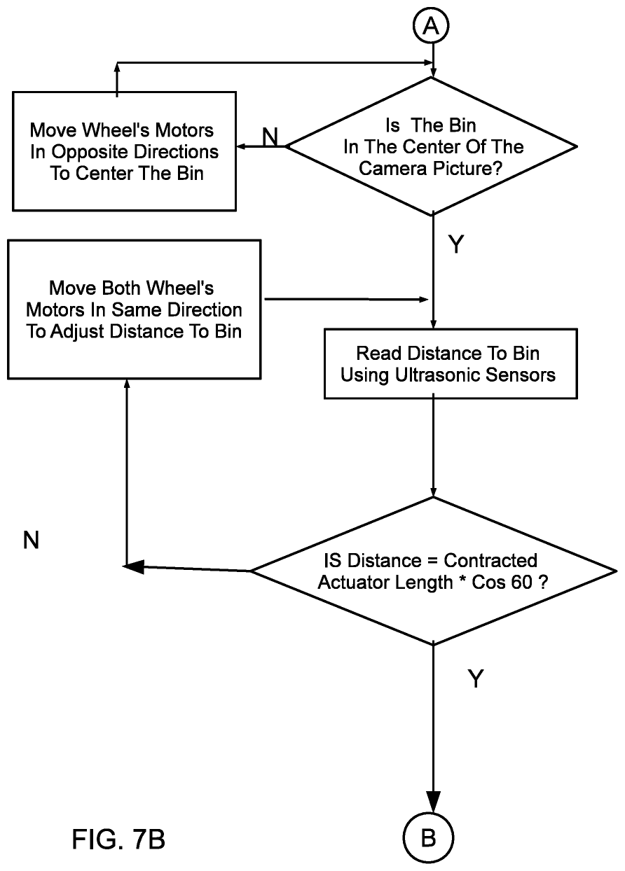

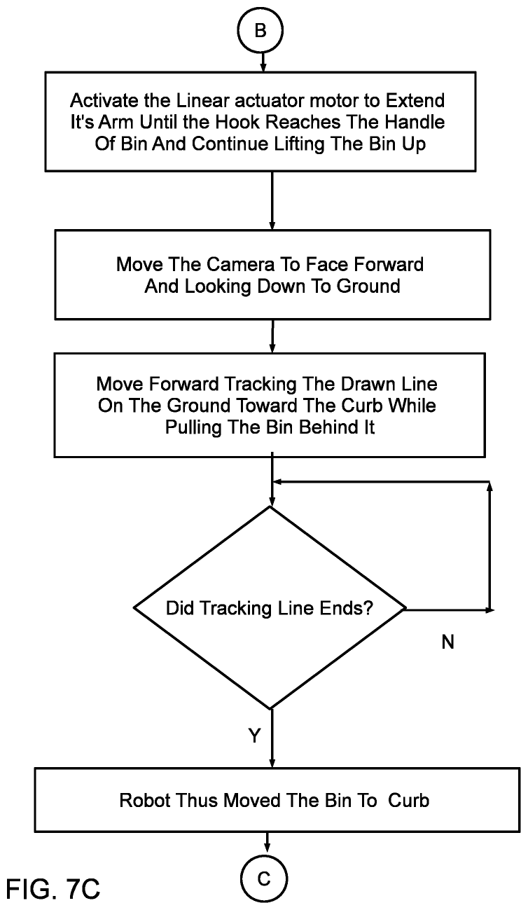

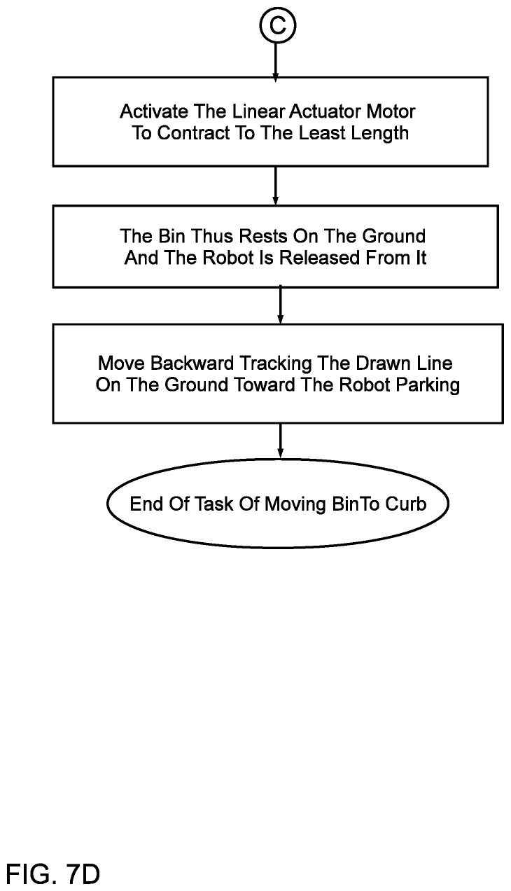

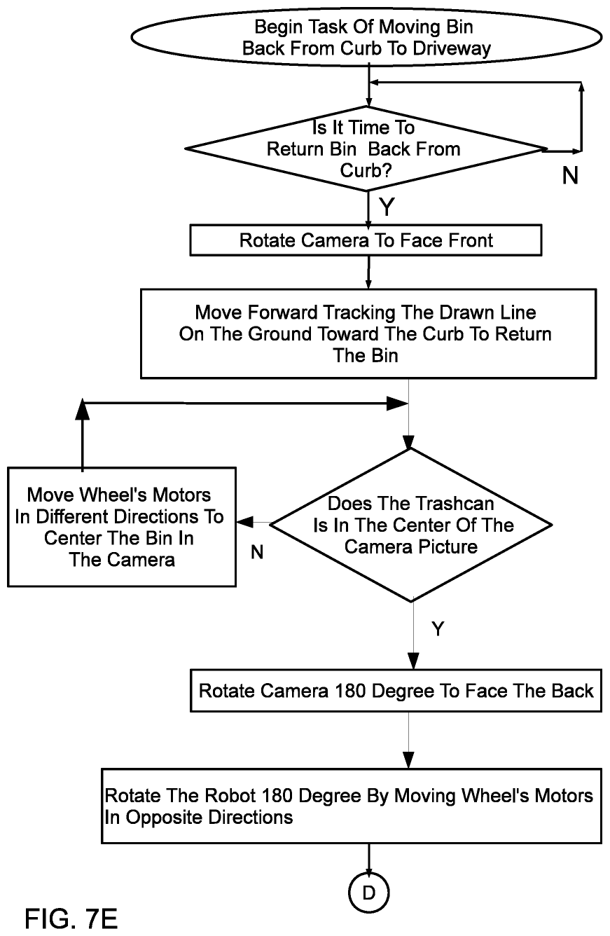

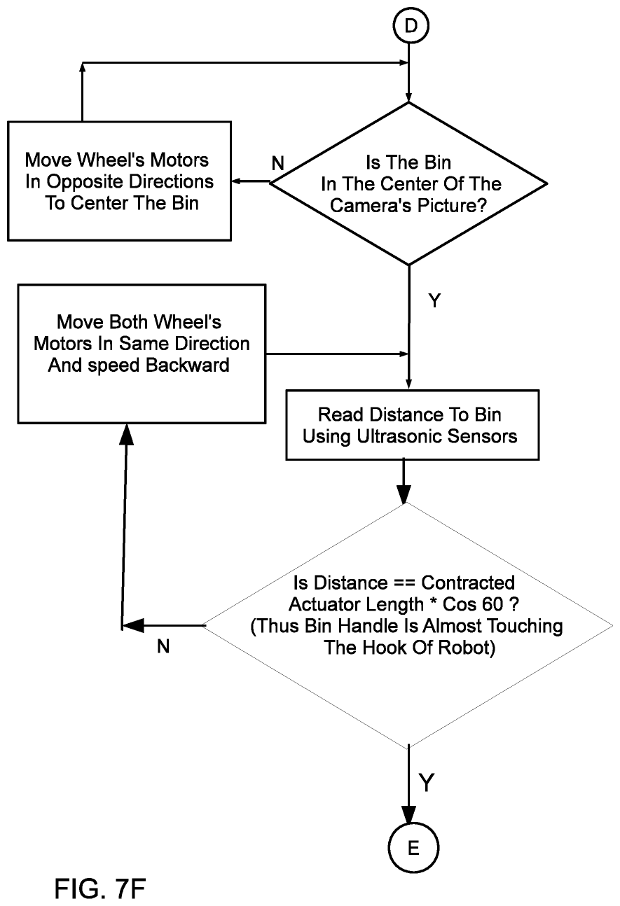

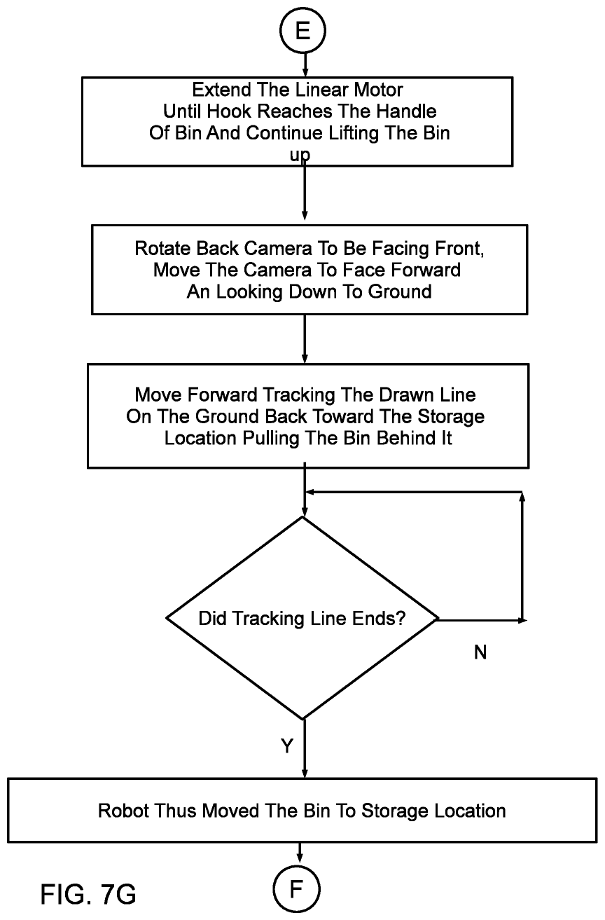

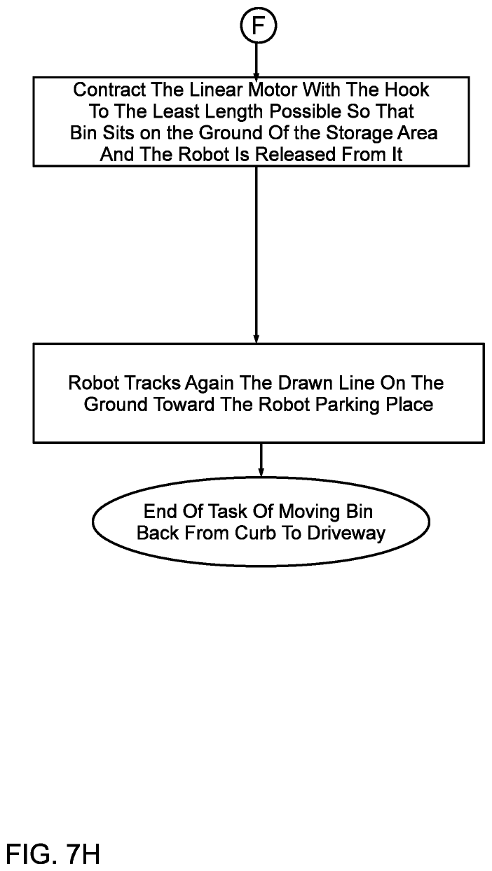

FIG. 7A through 7D are flowchart for task of moving bin from driveway to curbside.

FIG. 7E through 7H are flowchart for task of moving bin from curbside to driveway.

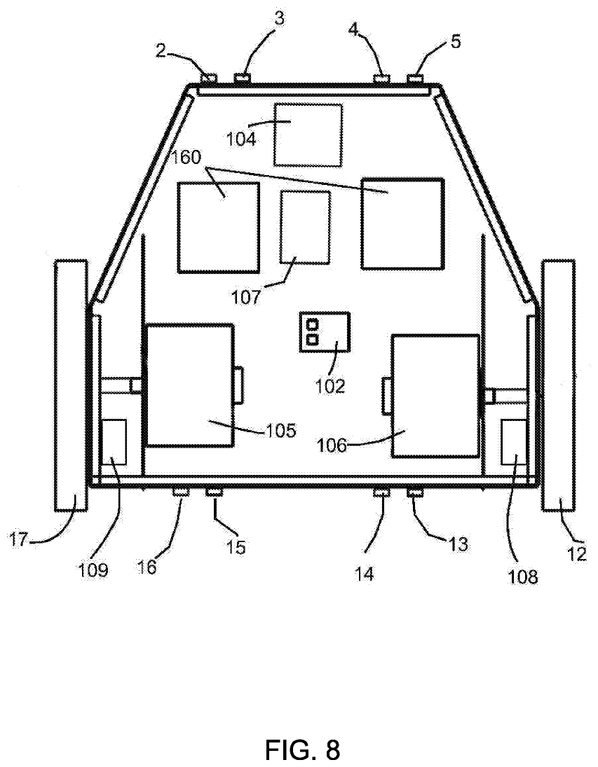

FIG. 8 is a cross-sectional top view of the robot showing one way of component placement.

Electric motors 105 and 106 are connected to the wheels either directly through the motor shaft or indirectly using a mechanical coupling like a gearbox.

A photo transmitter & receiver sensors 109 uses a circular pattern printed on the wheel to detect the angular position of the wheel 17. This is used for the closed-loop feedback with the PID controller for speed control and position control.

Same functionality for photo transmitter & receiver sensors 106 with the wheel 12.

What is claimed is:

1. A robot enabled to automatically relocate a refuse or recycle bin, comprising;
a housing including a top, bottom, front, back and two opposing sides;
means for storing and execution of artificial intelligence software enabled to operate the robot.
at least two support wheels operated by at least one electric motor and at least one ball caster;
at least one transmitter enabled to transmit ultrasound and one receiver enabled to receive the ultrasound, the transmitter and receiver mounted on at least one side of the housing;
a camera enabled to rotate 360°;
an articulated arm including one or more actuators enabled to extend and retract the arm; and
an engagement handle enabled to engage a bin handle located on the refuse or recycle bin;
wherein the robot learns a location of one or more of the refuse or recycle bins, via input from the camera, transmitters and receivers, to the software, and at a predetermined day and time, travels to the refuse or recycle bin location, operates the arm and engagement handle to engage the bin handle of the refuse or recycle bin and pushes, pulls or lifts the refuse or recycle bin on second wheels to a curbside location for collection, and after collection, returns the refuse or recycle bin to the location.

2. The robot of claim 1, wherein the engagement handle includes a semi-circular portion with straight sides extending away from the arm thereby forming a recess enabled to accept the handle of the refuse or recycle bin.

3. The robot of claim 1, wherein the at least two support wheels each have a diameter greater than a height of the housing.

4. The robot of claim 1, wherein additional transmitters and receivers are mounted on the top, back and sides of the housing.

5. The robot of claim 1, wherein the robot learns the location by following a direction line on ground between a resting location of the robot and the location of the refuse or recycle bin.

6. The robot of claim 5, wherein there is a direction line from a curbside location of the refuse or recycle bin and a storage location for the refuse or recycle bin.

7. The robot of claim 1, wherein the articulated arm is mounted at a center point between the two wheels.

8. The robot of claim 1, wherein the camera is mounted at the front of the housing and rotates 360 degrees with an ability to point up and down.

9. The robot of claim 2, wherein the refuse or recycle bins have two wheels on a same side as the handle is mounted and the articulated arm and engagement handle engage the bin handle to lean the refuse or recycle bin on the two wheels.

10. The robot of claim 9, wherein the bin handle is mounted in a recess running vertically below the bin handle, enabling the engagement handle and articulation arm to travel in the recess in order to engage the bin handle.

11. The robot of claim 7, wherein the articulated arm and engagement handle is enabled to lock into position after engagement with the bin handle, thereby maintaining a weight bearing center of gravity position.

12. The robot of claim 11, wherein the center of gravity position is maintained by moving the articulated arm towards the robot as the articulated arm extends to engage the bin handle.

13. The robot of claim 12, wherein at least one support wire connects the articulated arm to the housing and when the articulated arm fully extends into a vertical 90 degree position with the top of the housing and retracts to an acute angle towards the housing front.

14. The robot of claim 1, wherein the robot, via the software, distinguishes between recycle, refuse and bin ownership via anyone of bin color and barcodes labeling the refuse or recycle bins.
